(19) United States
(12) Patent Application Publication
(10) Pub. No.: US 2016/0215850 A1
(43) Pub. Date: Jul. 28, 2016

(54) Damping Devices Including Ferrofluid Enclosed by Folded Baffle

(71) Applicant: Caterpillar Inc., Peoria, IL (US)

(72) Inventor: Christopher Elliott, Apex, NC (US)

(73) Assignee: CATERPILLAR INC., Peoria, IL (US)

(21) Appl. No.: 14/603,607

(22) Filed: Jan. 23, 2015

(51) Int. Cl. F16F 9/53

(52) U.S. Cl. CPC F16F 9/535

(57) ABSTRACT

A damping device is disclosed. The damping device includes a housing and a piston disposed within the housing. The piston includes an electrical coil wound about the piston. The damping device includes a ferrofluid disposed radially outward of the piston and between the piston and the housing. The damping device further includes a foldable baffle disposed between the piston and the housing and defining an enclosure for the ferrofluid. The folded baffle is able to change shape during motion of the piston.

### TECHNICAL FIELD

The present disclosure generally relates to vibration damping devices and, more particularly, to vibration damping devices employing ferrofluids.

### BACKGROUND

Ferrofluids are fluids that have variable damping characteristics, wherein the damping characteristics depend upon the strength of a magnetic field imposed upon the fluid. This type of fluid has a shear stress that depends upon the magnetic flux imposed upon the fluid by an associated element, such as, for example, a current coil configured to produce a magnetic field. When a magnetic flux is imposed upon the fluid, the fluid becomes more difficult to shear.

The base fluids used in many ferrofluids (e.g., water, oil, glycol, etc.) are essentially incompressible and they are, therefore, often used in damping devices, such as shock absorbers and other dampers. In such a capacity, ferrofluids are often used as important components of damping devices and in the construction of controllable actuators due to the ferrofluids' dampening capabilities. Ferrofluids are, therefore, a valuable component of many piston-based damping devices.

In designing such damping devices, consideration must be made for effectively preventing leakage, or other such loss, of the ferrofluids from the damping device, especially since ferrofluids are often expensive. For example, U.S. Pat. No. 5,284,330 discloses seals at the ends of a damping device that prevent the fluid from exiting out of the device at the opening.

However, damping devices like those of the '330 patent require both a large volume of ferrofluid and the aforementioned end seals to prevent fluid loss. Such seals must be tight enough around an entry/exit point for an implement, such that the seal can prevent the ferrofluid from exiting while allowing for the implement to slide in and out of the damping device. High off-state damping may result from the friction caused by conventional seals that prevent ferrofluids from leaking from between moving parts. As such, a need exists for improvements relating to devices that use ferrofluids, including damping devices.

### SUMMARY

In accordance with one aspect of the disclosure, a damping device is disclosed. The damping device includes a housing and a piston disposed within the housing. The piston includes an electrical coil wound about the piston. The damping device includes a ferrofluid disposed radially outward of the piston and between the piston and the housing. The damping device further includes a foldable baffle disposed between the piston and the housing and defining an enclosure for the ferrofluid. The folded baffle is able to change shape during motion of the piston. In some examples, the folded baffle may include at least one baffle member, the at least one baffle member including a housing adjacent leg, a piston adjacent leg, and a fold connecting the housing adjacent leg to the piston adjacent leg.

In accordance with another aspect of the disclosure, an actuator is disclosed. The actuator includes a housing and a shaft partially enclosed within the housing. The actuator further includes a piston disposed within the housing and operatively associated with the shaft, the piston including an electrical coil wound about the piston. The actuator further includes a ferrofluid disposed radially outward of the piston and between the piston and the housing. The actuator further includes a foldable baffle disposed between the piston and between the piston and the housing and defining an enclosure for the ferrofluid. The folded baffle is able to change shape during motion of the piston. In some examples, the actuator further includes a spigot fluidly connected to the ferrofluid and allowing entry and exit of the ferrofluid from the enclosure defined by the folded baffle.

In accordance with yet another aspect of the disclosure, a method for damping vibration by using a damping device is disclosed. The method includes electrically charging an electrical coil associated with a piston of the damping device to produce a magnetic field. The method further includes receiving the magnetic field by a ferrofluid, the ferrofluid disposed radially outward of the piston and between the piston and the housing. The method further includes enclosing the ferrofluid using a folded baffle, the folded baffle disposed between the piston and the housing. The method further includes moving the piston within the housing in response to a vibration and changing shape of the folded baffle in response to moving the piston. In some examples, changing the shape of the folded baffle in response to moving the piston may include changing shape of the folded baffle to position the ferrofluid radially adjacent to the electrical coil.

These and other aspects and features of the present disclosure will be better understood when read in conjunction with the accompanying drawings.

### BRIEF DESCRIPTION OF THE DRAWINGS

FIG. 1 is a schematic representation of a damping device according to the present disclosure and is depicted in longitudinal cross-section.

FIG. 2 is a schematic representation of the damping device of FIG. 1, but depicted as a lateral cross section taken at the line 2-2 of FIG. 1.

FIG. 3 is a longitudinal cross-sectional view of an embodiment of a damping device, constructed in accordance with the present disclosure.

FIG. 4 is another longitudinal cross-sectional view of the damping device of FIG. 3, but depicted with a piston having an alternative displacement within the damping device.

FIG. 5 is a longitudinal cross-sectional view of a piston-based actuator, constructed in accordance with yet another embodiment of the present disclosure.

FIG. 6 is a flow chart representative of a method for damping vibration, in accordance with the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

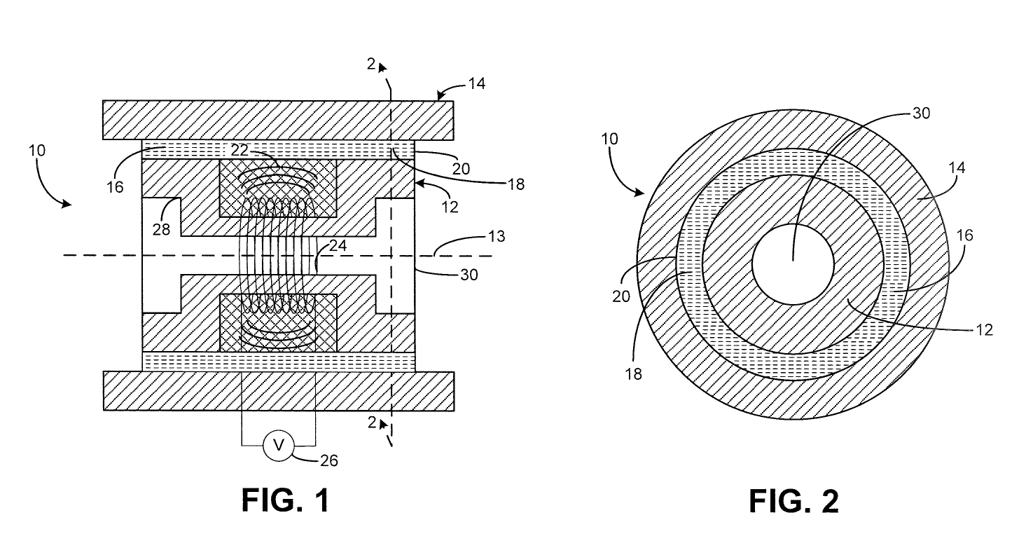

Turning now to the drawings, and with specific reference to FIGS. 1 and 2, a schematic representation of a damping device constructed in accordance with the teachings of the disclosure is generally referred to by reference numeral 10. The damping device 10 includes a piston 12 disposed along an axis 13 and movably mounted within a housing 14. The housing 14 and one or more elements of the piston 12 may be formed from a ferrous metal, such as iron, although other ferrous metals may be used. A ferrofluid 16 is disposed between the piston 12 and the housing 14. As shown best in combination with FIG. 2, the ferrofluid 116 is provided in a chamber 18, which is defined by a baffle 20.

The ferrofluid 16 is a fluid whose damping characteristics are affected by the presence of a magnetic field 22. A ferrofluid, generally, is a colloidal liquid that includes ferromagnetic particles suspended in a carrier liquid. Each ferromagnetic particle in the carrier fluid may be coated with a surfactant to inhibit clumping. The family of ferrofluids includes magnetorheological fluids (MR fluids), which include generally larger ferromagnetic particles than their related ferrofluid peers. The magnetic field 22 may be produced by, for example, an electrical coil 24 disposed within the piston 12. The electrical coil 24 may be powered by the power source 26, to produce the magnetic field 22. The magnetic field 22 produced by the electrical coil 24 is imposed upon the ferrofluid 16.

Ferrofluid 16 has a shear stress that depends upon the strength of magnetic flux imposed upon the ferrofluid 16 by the electrical coil 24. When a magnetic flux is imposed upon the ferrofluid 16, the ferrofluid 16 becomes more difficult to shear. Use of such ferrofluids 16 in the damping device 10 allows the device to have shear stress characteristics that are continuously controlled by varying the power provided to the electrical coil 24 by the power source 26, which, in turn, allows the magnetic field 22 to be varied. For example, if the strength of the magnetic field 22 is raised, the shear stress of the ferrofluid 16 is raised proportionally to the strength of the magnetic field 22. Inversely, if the strength of the magnetic field 22 is lowered, then the shear stress of the ferrofluid 16 is lowered proportionally to the strength of the magnetic field 22.

The piston 12 may include a ferrous material zone 28. The electrical coil 24 may be wound around the ferrous material zone 28, as the ferrous material of the ferrous material zone 28 may provide a low reluctance path for the magnetic field 22, such that a density of the magnetic flux of the magnetic field 22 can be maximized within the ferrofluid 16. However, the electrical coil 24 may be otherwise wound about the piston, so long as it is located radially inward of the ferrofluid 16. An opening 30 within the piston 12 is provided so that an implement, such as a shaft, may be provided to move with the piston 12 in applications wherein the damping device 10 is used as a component of a mechanical device, such as, but not limited to, an actuator. Other implements and devices, and, therefore, other shapes for the opening 30, are certainly possible.

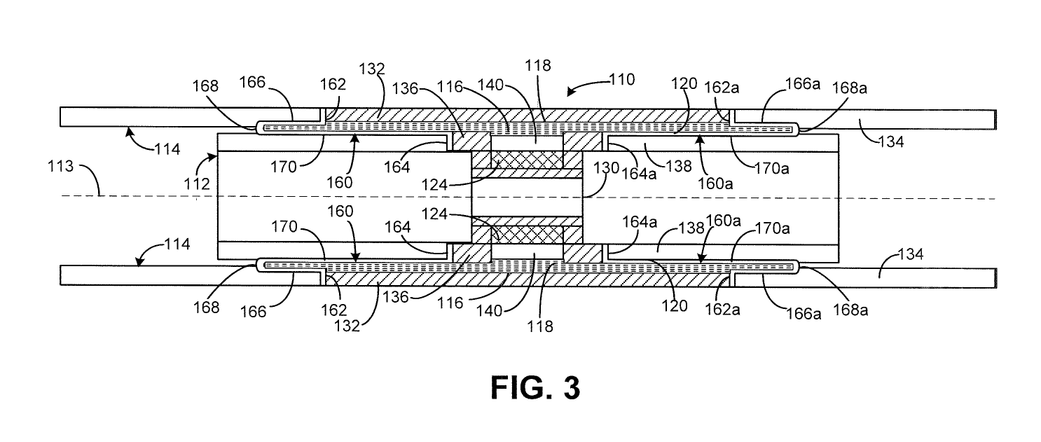

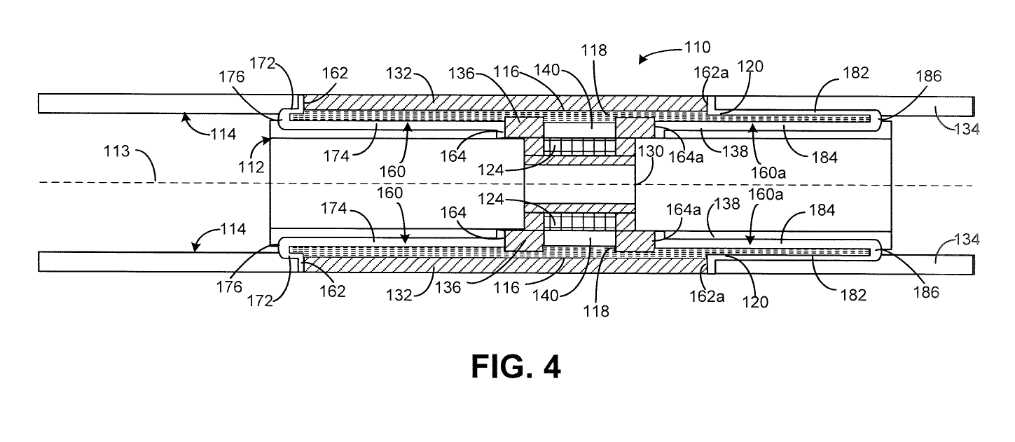

While FIGS. 1 and 2 schematically illustrate a damping device 10 according to the teachings of the present disclosure, FIGS. 3 and 4 depict a working embodiment of a damping device 110. As described hereafter, the damping device 110 will be described under 100 series numbering, so as to use a similar numbering scheme to the elements of FIGS. 1 and 2. As shown in FIGS. 3 and 4, the damping device 110 similarly includes a piston 112, a housing 114, a ferrofluid 116 disposed between the piston 112 and an electrical coil 124, and an opening 130 of the piston 112, the opening 130 suitable for an implement (not shown). The damping device 110 also includes a baffle 120 for enclosing the ferrofluid 116. More specifically, the baffle 120 defines a chamber 118 for containing the ferrofluid 116.

The housing 114 of the damping device 110 may include regions formed from different materials. For example, the embodiment of FIGS. 3 and 4 shows the housing 114 having a ferrous portion 132, which is comprised of a ferrous metal, such as iron, and a non-ferrous portion 134 comprised of a non-ferrous material, such as, but not limited to, a plastic or aluminum. Similarly, the piston 112 of FIGS. 3 and 4 has a ferrous region 136, which surrounds the electrical coil 124, and a non-ferrous mass 138 at both ends of the piston 112. Of course, the piston 112 does not require the non-ferrous mass 138; however, it may be useful because it may be made of a material having a lighter weight than the material of the ferrous region 136 and/or it may be made of a material having a lower cost than the material of the ferrous region 136.

In some examples, the piston 112 may include a buffer region 140 disposed between the electrical coil 124 and the ferrofluid 116. The buffer region 140 may be filled with any material, such as a tape or foam, to produce a gap between the ferrofluid 116 and the electrical coil 124. Alternatively, the buffer region 240 may be a volume filled with air and encased by a three dimensional enclosure like, for example, a plastic cylinder. Further, in some examples there may be no buffer region 140 present, so long as the fluid is prevented from leaking through the piston 112 to the electrical coil 124.

The baffle 120 is disposed between the piston 112 and the housing 114 and prevents the ferrofluid 116 from leaking or otherwise escaping into empty volumes of the interior of the housing 114. As shown in FIG. 3, the baffle 120 may include first member 160 and second member 160a. The first and second members 160, 160a may be attached to the housing 114, respectively, at a first housing connection point 162 and a second housing connection point 162a. Additionally, the first and second members 160, 160a may be connected to the piston 112 at first and second piston connection points 164, 164a.

The first and second members 160, 160a may respectively include first and second housing adjacent legs 166, 166a. The first and second housing adjacent legs 166, 166a extend from the first and second housing connection points 162, 162a to first and second folds 168, 168a. First and second piston adjacent legs 170, 170a extend from the first and second piston connection points 164, 164a to the first and second folds 168, 168a. The first and second housing adjacent legs 166, 166a and the first and second piston adjacent legs 170, 170a have a generally straight, wall-like shape.

While the embodiment of FIGS. 3 and 4 shows first and second housing connection points 162, 162a and first and second piston connection points 164, 164a, the baffle 120 is not necessarily connected to the piston 112 and housing 114 in such a manner. Functional equivalent arrangements are certainly possible, such as, for example, the baffle 120 being attached to the housing 114 and not the piston 112 and the first and second piston adjacent legs 170, 170a define a single wall adjacent to the piston 112. Similarly, functionally equivalent embodiments may include arrangements where the baffle 120 is attached to only the piston 112 and the first and second housing adjacent legs 166, 166a define a single wall adjacent to the housing 114. Further, the baffle 120 may include no attachments to either housing 114 or the piston 112; therefore, the first and second piston adjacent legs 170, 170a would define a single wall adjacent to the piston 112 and the first and second housing adjacent legs 166, 166a define a single wall adjacent to the housing 114.

Although the first member 160 and the second member 160a are shown having a relatively similar shape in FIG. 3, first and second members 160, 160a do not necessarily maintain a similar shape. The respective shapes of first and second members 160, 160a may change when the piston 112 is in motion. For example, FIG. 4 illustrates the damping device 110 having the piston 112 moved to the right along the axis 113 with respect to the housing 114 and in comparison to the piston 112 positioning shown in FIG. 3. When the piston 112 moves, the baffle 120 remains connected to the housing 114 via the first and second housing connection points 162, 162a and remains connected to the piston 112 via the first and second piston connection points 164, 164a. However, the shapes of first and second members 160, 160a may change with the motion.

When the piston 112 is moved to the right along the axis 113, the shape of the first member 160 may include a first moved housing adjacent leg 172 connected to a first moved piston adjacent leg 174 via a moved fold 176. Similarly, the second member 160a includes a second moved housing adjacent leg 182 and a second moved piston adjacent leg 184, which are connected via a second moved fold 186. The first and second moved housing adjacent legs 172, 182 and the first and second moved piston adjacent legs 174, 184 may be elongated or shortened in response to the motion of the piston 112, while maintaining a generally straight wall shape. Positioning of first and second moved folds 176, 186, with respect to the overall structure of the baffle 120, may shift with the motion of the piston 112.

The baffle 120 of FIGS. 3 and 4 is flexible and may be generally toroidal in shape. The term “toroidal,” generally, is an adjective describing a structure that resembles a toroid. A toroid is a round object having an opening in the middle, which is often referred to, colloquially, as a “donut-shaped” object. The baffle 120 may also be shaped like other ringed shapes (e.g., an annulus), so long as it is disposed between the housing 114 and the piston 112 and has flexible walls connected at a fold. The baffle 120 encloses the ferrofluid 116, while having walls that are not entirely attached or sealed to either the housing 114 or the piston 112. By not being entirely sealed to other elements and having flexible walls that can change in length, the baffle 120 can change shape as the piston 112 moves within the housing 114.

As such, the ferrofluid 116 may remain adjacent to the piston 112, during motion. Moreover, by manufacturing the baffle 120 from a flexible material, if the piston 112 moves along the transverse axis 113, the ferrofluid 116 can be remain properly positioned with respect to the electrical coil 124 (e.g., positioning adjacent to the electrical coil 124) during motion of the piston 112. As shown in FIG. 4, the piston 112 is moved to the right along the axis 113, with respect to the housing 114 and in comparison to its positioning shown in FIG. 3. In FIG. 4, the baffle 120 changes shape in a manner which moves the chamber 118 containing the ferrofluid 116 to the right with the piston 112. Such movement of the chamber 118 allows the ferrofluid 116 to remain positioned adjacent to the electrical coil 124, such that the ferrofluid 116 can accept a magnetic field produced by the electrical coil 124. Such a baffle 120 allows for the shown repositioning of the chamber 118.

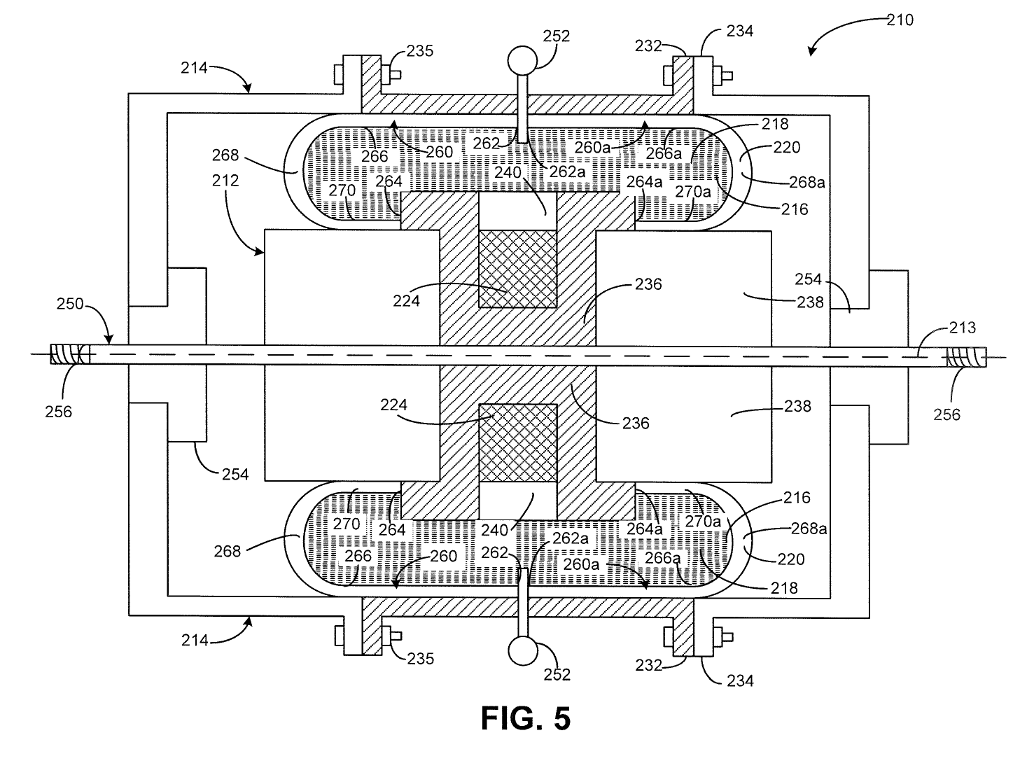

Turning to FIG. 5, an actuator 210 having a damping device, as described above, is shown. The actuator 210 includes generally similar elements as mentioned above, but further includes, at its radial center, a shaft 250 operatively associated with a piston 212, which moves, linearly along axis 213, within a housing 214 of the actuator 210. The actuator 210 includes a ferrofluid 216 between of the piston 212 and the housing 214. An electrical coil 224 is provided to produce a magnetic field, which may be used to continuously control the shear strength of the ferrofluid 216.

The ferrofluid 216 is enclosed in a chamber 218 within the housing 214, the chamber 218 defined by a baffle 220. Similarly to the damping device 110 of FIGS. 3 and 4, the baffle 220 is disposed between the piston 212 and the housing 214 and generally has a flexible shape. The baffle 220 encloses the ferrofluid 216, while not being entirely attached or sealed to any other element of the actuator 210. By not being entirely sealed to either the housing 214 or the piston 212 and being flexible, the baffle 220 can change shape when the piston 212 moves with the shaft 250. As such, the ferrofluid 216 may remain positioned adjacent to the electrical coil 224 during motion of the piston 112.

The housing 214 may include ferrous portions 232 and non-ferrous portions 234, which may be connected via fasteners 235. Further, the piston 212 has a ferrous region 236, which surrounds the electrical coil 224, and a non-ferrous mass 238 at both ends of the piston 212. The piston 212 does not require the non-ferrous mass 238; however, it may be useful because it may be made of a material having a lighter weight than the material of the ferrous region 236 and/or it may be made of a material having a lower cost than the material of the ferrous region 236. Additionally, the piston 212 may include a buffer region 240 disposed between the electrical coil 224 and the ferrofluid 216. The buffer region 240 may be filled with any material, such as a tape or foam, to produce a gap between the ferrofluid 216 and the electrical coil 224. Alternatively, the buffer region 240 may be a volume filled with air and encased by a three dimensional enclosure like, for example, a plastic cylinder. The buffer region 240 may be any object or space designed to prevent the ferrofluid 216 from leaking through the piston 212 to the electrical coil 224.

The housing 214 may further include a spigot 252 which allows access to the chamber 218 enclosed by the baffle 220, to fill the chamber 218 with the ferrofluid 216 from the exterior of the housing 214. In some examples, the spigot 252 may be used to drain excess air from within the chamber 218 enclosed by the baffle 220. In some examples, the housing 214 may include a low friction interface 254, in which the shaft 250 is inserted. The shaft 250 moves in and out of the low friction interface 254. The low friction interface 254 may be a sleeve interface, such as, but not limited to, a plastic sleeve or a bronze bushing. The shaft 250 may have threaded ends 256 suitable for attaching the actuator 210 to a mechanical device, such as a shaker.

The baffle 220 may include first and second members 260, 260a which may be attached to the housing 114, respectively, at first and second housing connection points 262, 262a. While in the illustration of FIG. 5 the first and second housing connection points 262, 262a are shown on opposing ends of the spigot 252, the first and second housing connection points 262, 262a may be located at any point on the housing 214, such that the baffle 220 maintains its shape flexibility. The baffle 220 may also be connected to the piston 212 at first and second piston connection points 264, 264a.

The first and second members 260, 260a may respectively include first and second housing adjacent legs 266, 266a. The first and second housing adjacent legs 266, 266a extend from the first and second housing connection points 262, 262a to first and second folds 268, 268a. First and second piston adjacent legs 270, 270a extend from the first and second piston connection points 264, 264a to the first and second folds 268, 268a. The first and second housing adjacent legs 266, 266a and the first and second piston adjacent legs 270, 270a have a generally straight, wall-like shape.

While the embodiment of FIG. 5 shows first and second housing connection points 262, 262a and first and second piston connection points 264, 264a, the baffle 220 is not necessarily connected to the piston 212 and housing 214 in such a manner. Functional equivalent arrangements are certainly possible, such as, for example, the baffle 220 being attached to the housing 214 and not the piston 212 and the first and second piston adjacent legs 270, 270a, in combination, define a single wall adjacent to the piston 212. Similarly, functionally equivalent embodiments may include arrangements where the baffle 220 is attached to only the piston 212 and the first and second housing adjacent legs 266, 266a, in combination, define a single wall adjacent to the housing 214. Further, the baffle 220 may include no attachments to either housing 214 or the piston 212; therefore, the first and second piston adjacent legs 270, 270a would define a single wall adjacent to the piston 212 and the first and second housing adjacent legs 266, 266a define a single wall adjacent to the housing 214.

Although the first member 260 and the second member 260a are shown having a relatively similar shape in FIG. 5, first and second members 260, 260a do not necessarily maintain a similar shape. The respective shapes of first and second members 260, 260a may change when the piston 212 is in motion. When the piston 212 moves, for example, about the axis 213, the shapes of the first and second member 260, 260a may change with the motion. During such motion, the first and second housing adjacent legs 266, 266a and/or the first and second piston adjacent legs 270, 270a may be individually elongated or shortened in response to the motion of the piston 212, while maintaining a generally straight wall shape. In the course of the piston 212 moving, positioning of the first and second folds 268, 268a may move or shift.

Similar to the baffle 120 of FIGS. 3 and 4, the baffle 220 is flexible and, in some examples, may be generally toroidal in shape. Alternatively, the baffle 220 may be shaped like other generally ringed structures (e.g., an annulus), so long as it is disposed between the housing 214 and the piston 212 and has flexible walls connected at a fold.

### INDUSTRIAL APPLICABILITY

The present disclosure sets forth piston-based vibration damping devices, and, more particularly, vibration damping devices having a folded baffle for enclosing a ferrofluid. The folded baffle encloses the ferrofluid between a piston and a housing of the vibration damping device. Seals in ferrofluid based damping devices are important, because without any type of sealing the entire device would have to be submerged in a ferrofluid, which would require large a volume of ferrofluid. Reduction of the volume of ferrofluid is useful in lowering the cost of damping devices.

Use of a folded baffle allows for low off-state damping while using a cost efficient volume of ferrofluid, because the baffle mitigates the need for seals at sliding surfaces where implements enter and exit the damping device (e.g., the low friction interfaces 254 of FIG. 5). For any damping device containing a ferrofluid, the fluid can be sealed to prevent it from exiting the device. By avoiding sealing a gap with a sliding seal and using a folded baffle to enclose the ferrofluid, there may be less friction at the entry/exit point of the implement (e.g., the low friction interface 254 of FIG. 5, wherein the shaft 250 enters/exits the housing 214), while also using a cost efficient volume of ferrofluid.

Further, use of such a flexible baffle may allow for minimal ferrofluid use because the fluid can be contained in a very small volume, in comparison to past damping based devices wherein the fluid is not similarly enclosed and encompasses a large volume of the interior of a housing of said device.

The disclosed damping devices may be useful in a variety of vibration damping applications, such as, but not limited to, damping devices associated with user controls in heavy machines. Such user controls may employ haptic feedback schemes, in which vibration damping devices may be used for greater feedback control. For example, if an actuator, such as the actuator 210, is attached to a joystick of a user control system, the force required for an operator of the system to move the joystick could be varied to give the operator feedback. Such feedback may be representative of a force on a machine implement or the feedback may be used to prevent unwanted joystick motion.

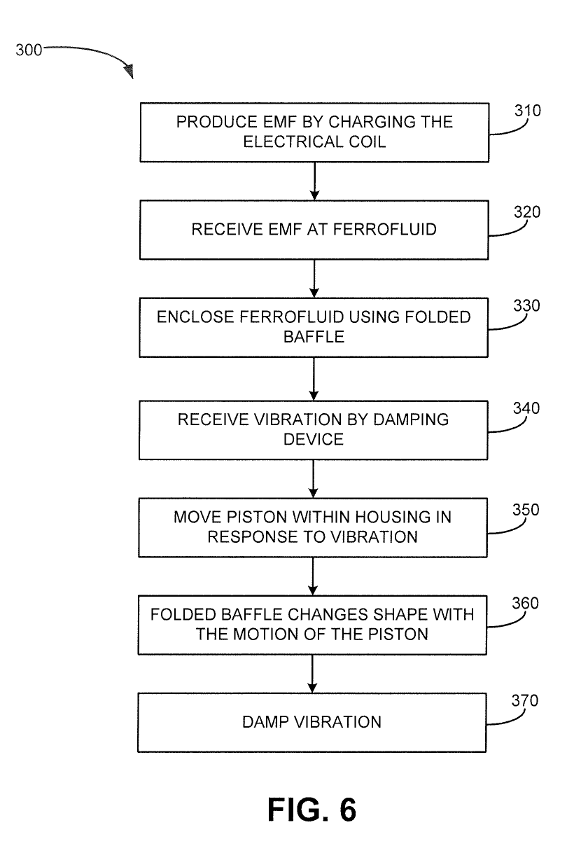

The flowchart of FIG. 6 illustrates a method 300 for damping vibration using a damping device as described above. For the following description, specific reference is made to the damping device 110 of FIGS. 3 and 4. The electrical coil 124 is charged or otherwise energized by a power source to produce a magnetic field, as shown in block 310. The electrical coil 124 is operatively associated with the piston 112. In some examples, the electrical coil 124 may be variably charged to produce a variable magnetic field. At block 320, the magnetic field is received by a ferrofluid 116. The ferrofluid 116 is disposed within the housing 114.

At block 330, the method further includes enclosing the ferrofluid 116 using the folded baffle 120. The folded baffle 120 is disposed between the piston 112 and the housing 114. In some examples, the damping device may receive a vibration, as seen in block 340. The vibration may be received via an implement, such as, for example, a shaft that interfaces with the piston 112 at the opening 130. Such a vibration may move the implement and, in turn, move the piston 112, as seen in block 350.

In response to the movement of the piston 212, the folded baffle 120 may change shape, as seen in block 370. Changing the shape of the folded baffle 120 may position the ferrofluid 116 radially adjacent to the electrical coil 124. Further, changing shape of the folded baffle 120 may include shortening or elongating one or more of the first and second housing adjacent legs 166, 166a and the first and second piston adjacent legs 170, 170a.

Because the baffle 120 is able to change shape with motion of the piston 112, it allows the damping device 110 to be designed using a lesser amount of fluid than alternative devices, as the entirety of the interior volume of the housing 114 surrounding the piston 112 would need to be filled with ferrofluid 116 to achieve proper damping. Further, because the baffle 120 is not entirely sealed to either the piston 112 or the housing 114, it allows for low friction damping when using the damping device 110. By employing the method 300, the vibration may then be damped, as shown in block 380.

It will be appreciated that the present disclosure provides apparatus and methods for vibration damping. While only certain embodiments have been set forth, alternatives and modifications will be apparent from the above description to those skilled in the art. These and other alternatives are considered equivalents and within the spirit and scope of this disclosure and the appended claims.

What is claimed is:

1. A damping device, comprising:
a housing;
a piston disposed within the housing and including an electrical coil wound about the piston;
a ferrofluid disposed radially outward of the piston and between the piston and the housing; and
a folded baffle disposed between the piston and the housing and defining an enclosure for the ferrofluid, the folded baffle able to change shape during motion of the piston.

2. The damping device of claim 1, wherein the folded baffle includes at least one baffle member, the at least one baffle member including a housing adjacent leg, a piston adjacent leg, and a fold connecting the housing adjacent leg to the piston adjacent leg.

3. The damping device of claim 2, wherein the at least one baffle member is attached to the housing, in part, at a housing connection point.

4. The damping device of claim 2, wherein the at least one baffle member is attached to the piston, in part, at a piston connection point.

5. The damping device of claim 2, wherein the housing adjacent leg and the piston adjacent leg are generally wall-like structures disposed, respectively, adjacent to the housing and the piston.

6. The damping device of claim 2, wherein the folded baffle changes shape during motion of the piston by elongating or shortening one or both of the housing adjacent leg and the piston adjacent leg.

7. The damping device of claim 1, wherein the folded baffle includes:
a first member having a first housing adjacent leg connected, in part, to the housing and a first piston adjacent leg connected, in part, to the piston, the first housing adjacent leg and first piston adjacent leg connected at a first fold; and
a second member having a second housing adjacent leg connected, in part, to the housing and a second piston adjacent leg connected, in part, to the piston, the second housing adjacent leg and second piston adjacent leg connected at a second fold.

8. The damping device of claim 1, wherein the folded baffle is generally toroidal in shape.

9. The damping device of claim 1, wherein the piston further includes:
a ferrous portion formed of a ferrous metal; and
a non-ferrous portion formed of a non-ferrous material.

10. The damping device of claim 1, wherein the housing includes:
a ferrous portion formed of a ferrous metal; and
a non-ferrous portion formed of a non-ferrous material.

11. An actuator, comprising:
a housing;
a shaft partially enclosed within the housing;
a piston disposed within the housing and operatively associated with the shaft, the piston including an electrical coil wound about the piston;
a ferrofluid disposed radially outward of the piston and between the piston and the housing; and
a folded baffle disposed between the piston and the housing and defining an enclosure for the ferrofluid, the folded baffle able to change shape during motion of the piston.

12. The actuator of claim 11, wherein the folded baffle includes at least one baffle member, the at least one baffle member including a housing adjacent leg, a piston adjacent leg, and a fold connecting housing adjacent leg to the piston adjacent leg.

13. The actuator of claim 12, wherein the housing adjacent leg and the piston adjacent leg are generally wall-like structures disposed, respectively, adjacent to the housing and the piston.

14. The actuator of claim 12, wherein the folded baffle changes shape during motion of the piston by elongating or shortening one or both of the housing adjacent leg and the piston adjacent leg.

15. The actuator of claim 11, further comprising a spigot fluidly connected to the ferrofluid and allowing entry and exit of the ferrofluid from the enclosure defined by the folded baffle.

16. A method for damping vibration by using a damping device, the method comprising:
electrically charging an electrical coil associated with a piston of the damping device to produce a magnetic field;
receiving the magnetic field by a ferrofluid, the ferrofluid disposed radially outward of the piston and between the piston and the housing,
enclosing the ferrofluid using a folded baffle, the folded baffle disposed between the piston and the housing;
moving the piston within the housing in response to a vibration; and
changing shape of the folded baffle in response to moving the piston.

17. The method of claim 16, wherein changing the shape of the folded baffle in response to moving the piston includes changing shape of the folded baffle to position the ferrofluid radially adjacent to the electrical coil.

18. The method of claim 16, further comprising receiving the vibration by a shaft, the shaft operatively associated with the piston.

19. The method of claim 16, wherein electrically charging the electrical coil includes variably charging the electrical coil to produce a variable strength magnetic field.

20. The method of claim 16, wherein changing shape of the folded baffle in response to moving the piston includes shortening or elongating one or both of a housing adjacent leg of the folded baffle and a piston adjacent leg of the baffle.
